(19) United States
(12) Patent Application Publication
(10) Pub. No.: US 2014/0343955 A1
(43) Pub. Date: Nov. 20, 2014

(54) METHOD AND APPARATUS FOR PROVIDING A PREDICTIVE HEALTHCARE SERVICE

(71) Applicant: Verizon Patent and Licensing Inc., Basking Ridge, NJ (US)

(72) Inventor: Madhusudan Raman, Sherborn, MA (US)

(73) Assignee: Verizon Patent and Licensing Inc., Basking Ridge, NJ (US)

(21) Appl. No.: 13/896,003

(22) Filed: May 16, 2013

(51) Int. Cl. G06F 19/00

(52) U.S. Cl. CPC G06F 19/3431; G06F 19/345
USPC 705/2

(57) ABSTRACT

An approach for providing a predictive healthcare service includes generating an ensemble model for predicting one or more health classifications based on one or more health variables, the ensemble model consisting of a plurality of predictive models. The approach also includes tuning the ensemble model based on a test data set and providing a predictive healthcare service based on the ensemble model.

### BACKGROUND INFORMATION

Generally, healthcare diagnosis and prognosis have historically been dependent on the expertise of healthcare professionals. As the number and complexity of the variables that feed into healthcare diagnosis/prognosis increases, the dependence on such expertise also increases. Accordingly, healthcare professionals may become more specialized and require even more intensive training to acquire such expertise. In some cases, medical diagnoses may require extensive and multiple examinations, tests, etc., particularly for diseases or health conditions that are asymptomatic or have very subtle symptoms. At the same time, developments in data analytics are providing means to leverage advances computer and communications technologies to make healthcare expertise more available and timely. As a result, service providers face significant technical challenges applying such technologies in the healthcare domain.

Based on the foregoing, there is a need for an approach for providing predictive healthcare as a technology service (e.g., a cloud service) to assist healthcare professionals in making healthcare diagnoses.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing a predictive healthcare service, according to one embodiment;

FIG. 2 is a diagram of a system utilizing a predictive healthcare platform over a cloud network, according to one embodiment;

FIG. 3 is a diagram of a predictive healthcare platform, according to one embodiment;

FIG. 4 is a diagram illustrating use of a diagnosis model for determining a diagnosis classification, according to one embodiment;

FIG. 5 is a flowchart of a process for providing a predictive healthcare service, according to one embodiment;

FIG. 6 is a flowchart of a process for preparing and exploring data sets for use in a predictive healthcare service, according to one embodiment;

FIG. 7 is a diagram of a computer system that can be used to implement various exemplary embodiments; and

FIG. 8 is a diagram of a chip set that can be used to implement various exemplary embodiments.

### DESCRIPTION OF THE PREFERRED EMBODIMENT

An apparatus, method, and software for providing a predictive healthcare service are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although various embodiments are described with respect to predicting or making healthcare classifications with respect to coronary artery disease (CAD) and Parkinson's disease (PD), it is contemplated that the embodiments described herein are applicable to any disease or health condition that can be modeled according the example processes described below. In addition, although the various embodiments discuss predictive healthcare models focusing on diagnosis of disease and/or health conditions, it is contemplated that the embodiments are also applicable to predicting prognosis of the disease and/or health condition.

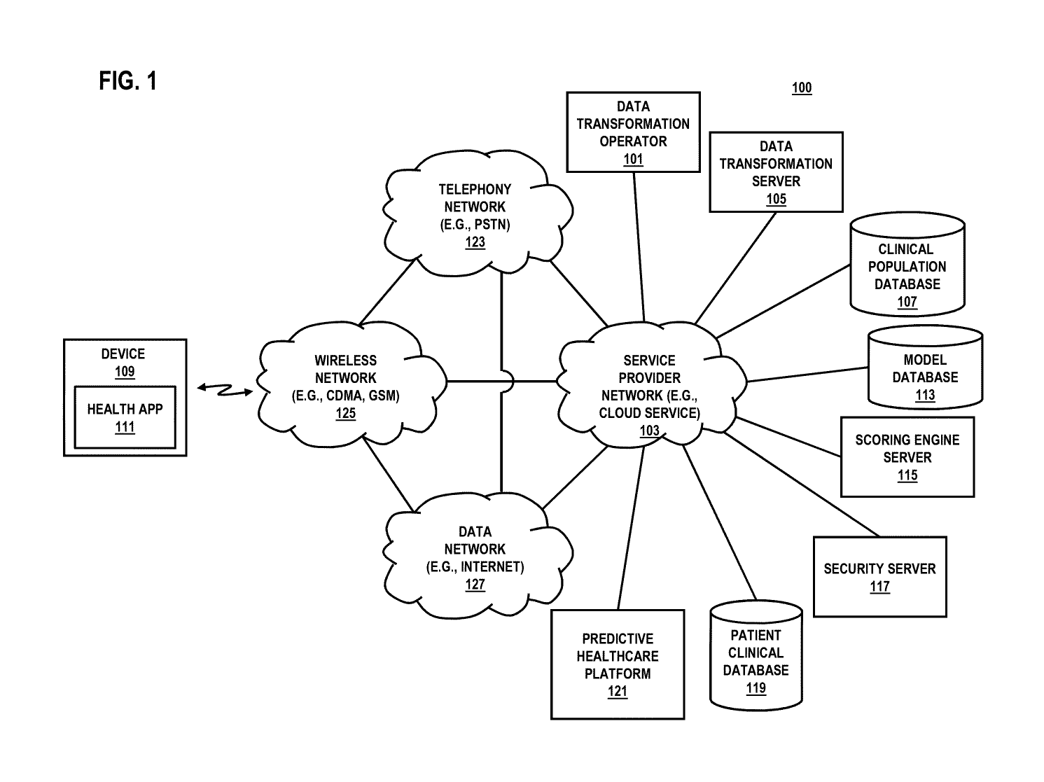

FIG. 1 is a diagram of a system capable of providing a predictive healthcare service, according to one embodiment. As noted above, the field of healthcare diagnosis and prognosis can be challenging even for healthcare professionals with high levels of expertise. For example, in the context of heart disease, which is usually called coronary artery disease (CAD) is considered the “top” killer disease in the world. Many CAD patients have symptoms such as chest pain (angina) and fatigue, which occur when the heart is not receiving adequate oxygen. Nearly 50% of patients, however, have no symptoms until a heart attack occurs. Historically, cardiac catheterization or coronary angiogram is considered as the “gold standard” method to diagnose the presence of CAD. These methods have high accuracy but are generally invasive, expensive, and not practical as diagnostic tools for large populations. Accordingly, there has been significant effort to diagnose CAD using less expensive and non-invasive methods such as electrocardiogram (ECG) based analysis, heart sound analysis, medical imaging analysis, etc. As another example, Parkinson's disease (PD) is the second most commonly diagnosed neurodegenerative disease. PD affects approximately 1% of the world's population. Symptoms of disease or abnormal conditions as those apparent in PD are increasing at a rate greater than the natural aging of the population. When combined with the large demographic of the “baby boom” generation (e.g., those born from 1945 to 1960) that is approaching the age when diseases such as CAD and PD become apparent, there is an anticipated large increase in the need for classification (e.g., diagnosis) and ongoing monitoring for such diseases.

To address the need, a system 100 of FIG. 1 introduces a predictive healthcare system and service that provides diagnosis and prognosis services associated with specific disease models (e.g., CAD and PD disease models). By way of example, predictive health or healthcare is a broad term. At its broadest, predictive healthcare encompasses the potential to proactively “forge personal strategies for healthier living before a small glitch blows up into a major disease” (Brigham, K., Johns, M. “Predictive Health: How We Can Reinvent Medicine to Extend Our Best Years,” Basic Books, Oct. 2, 2012). More specifically, in one embodiment, the predictive healthcare service of system 100 leverages “big data” (e.g., population wide health data) in order to provide contextual transformation of data into insights for healthcare or disease diagnosis and/or classification. Use of the system 100 can reduce the burden on health professionals (or on consumers themselves if permitted by regulatory authorities) to obtain disease diagnoses and/or prognoses, thereby making a positive impact on the cost and quality of healthcare. For example, use of predictive healthcare services or healthcare classification systems such as system 100 can help in increasing accuracy and reliability of diagnoses, minimizing possible errors, as well as making the diagnoses more time efficient.

In one embodiment, the system 100 follows a multi-step process for setting up a predictive healthcare service and delivering the service via the cloud. For example, the multi-step process (as described in more detail below) may include any combination of the following steps: (1) prepare a data set, (2) explore the data set, (3) prepare the model, (4) tune the model, (5) setup the service, and (6) use the service. As shown in the example of FIG. 1, a data transformation operator 101 via service provider network 103 (e.g., a cloud service) starts the process of preparation or aggregation of the data set on a data transformation server 105 of clinical population data in the database 107 covering, e.g., health and diseased individuals. In one embodiment, the clinical population data is anonymized to protect the privacy of the individuals.

After domain specific validation of the unstructured clinical population data that has been gleaned, for instance, via associated data spidering activities, the data transformation operator 101 explores the data collated for a specific disease or healthcare classification (e.g., CAD or PD). In one embodiment, as part of data exploration, the system 100 performs variables optimization where statistical tests (e.g., data distributions associated with the variables) are performed by a script on the data to identity variables in the population data (e.g., age, resting blood pressure, height, chest pain, etc.) that can be dropped from consideration or needs to be included essentially. In one embodiment, the variables refer to healthcare or clinical readings or observations from a device 109 (e.g., a clinical device or a user device if permitted by regulatory authorities) and/or health application 111 executing on the device 109. For example, if the statistical tests indicate that there is either redundant benefits in including a specific variable or on the other hand no or little correlation between a variable and the disease or health classification of interest, then the variable can be dropped.

In one embodiment, the application 111 is a business-to-business-to-enterprise (B2B2E) application that puts a face to the ensemble model and a point of interaction for the care giver. By way of example, the B2B2E application 111 can have an extensive set of features including: (1) application issuance and on-boarding support; (2) real-time and post-consultative analysis; (3) clinical data archiving; (4) near-real time scoring; (5) visual and spoken (e.g., text-to-speech) feedback; (6) traditional disease risk calculators; (7) referenced output scores showing clinical references; etc. Although the application 111 is described as a B2B2E application, it is contemplated that the application 111 may also be a consumer facing application if permitted or approved by regulatory authorities.

In one embodiment, the remaining variables and associated data are used to generate a model file (e.g., stored in the model database 113). In one embodiment, the models are ensemble models comprising multiple models of multiple types (e.g., experiential models such as neural networks, regression models, etc.). In one embodiment, the models adhere to the Predictive Modeling Markup Language (PMML) standard. By way of example, the ensemble models of the system 100 support a combination of data-driven insight and expert knowledge into a single and powerful decision strategy. Neural network models, for instance, encapsulate “experiential” rules used by clinical experts to solve diagnostic problems (e.g., expert knowledge). Then predictive analytics augments the experiential rules based on an ability to automatically recognize patterns in data not obvious to the expert eye. As a result, the ensemble model approach described herein uses more than one model to arrive at a consensus classification for a given disease or health classification. In one embodiment, linear regression and neural network models are combined into a predictive scorecard leveraging a PMML cloud based engine (e.g., supported by a scoring engine server 115). The neural network model represents, for instance, a model trained by use of a back propagation algorithm and is composed of an input layer, one or more hidden layers, and an output layer. The generated model file is then loaded on the scoring engine server 115 in the cloud service 103 to make the predictive healthcare service available to end users.

In one example use case, when a patient visits a caregiver, the caregiver can use the device 109 (e.g., a rugged mobile device such as a tablet or a mobile phone) to bring up the health application 111 (e.g., a predictive healthcare application). The caregiver, for instance, choses the appropriate disease or health condition information on the application 111. In one embodiment, the health application and/or the device 109 makes a request for further authentication to a cloud-based security server 117 in order to use the patient's clinical data (e.g., stored in patient clinical database 119). In one embodiment, the authentication scheme and associated components of the system 100 are compliant with privacy and security requirements (e.g., requirements specified by the Health Insurance Portability Act of 1996 (HIPAA) and/or other regulatory authorities).

Once the application 111 is populated with the appropriate data (e.g., data from the patient clinical database 111 and/or health readings/observations collected directly by the device 109 and/or application 111), the application 111 makes a request to the predictive healthcare platform 121 (e.g., via a predictive management services interface) in the cloud service 103 for a health classification or diagnosis. In one embodiment, a positive or negative indication is provided as a response specific to the disease or health condition of interest by consulting the disease model running on the predictive or scoring engine server 115.

In another example use case, a 70-year-old man (e.g., Patient A) with a typical chest pain and a normal maximal treadmill test would probably not be referred for angiography. However, a percentage of such individuals will indeed have CAD. Unfortunately, clinicians who perhaps justifiably do not order a coronary angiogram in this situation might then tend to dismiss Patient A's complaints as being insignificant and unworthy of follow-up. This may be done in order not to admit uncertainty. In Patient A's case, the predictive healthcare service of system 100 can provide immediate feedback to the clinician based on Patient A's current clinical measurements in consultation with the cloud-based CAD diagnosis model executing on the scoring engine server 115. The system 100 thus could enable the clinician to additionally consider the strength of the “CAD risk” scoring as to whether angiography is indicated in consultation with the traditional and “predictive” risk scores.

For illustrative purposes, the device 109 and/or health application 111 have connectivity to the service provider network 103 via one or more of networks 103 and 123-127. In one embodiment, networks 103 and 123-127 may be any suitable wireline and/or wireless network, and be managed by one or more service providers. For example, telephony network 123 may include a circuit-switched network, such as the public switched telephone network (PSTN), an integrated services digital network (ISDN), a private branch exchange (PBX), or other like network. Wireless network 111 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 113 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 103 and 123-127 may be completely or partially contained within one another, or may embody one or more of the aforementioned infrastructures. For instance, the service provider network 103 may embody circuit-switched and/or packet-switched networks that include facilities to provide for transport of circuit-switched and/or packet-based communications. It is further contemplated that networks 103 and 123-127 may include components and facilities to provide for signaling and/or bearer communications between the various components or facilities of system 100. In this manner, networks 103 and 123-127 may embody or include portions of a signaling system 7 (SS7) network, or other suitable infrastructure to support control and signaling functions.

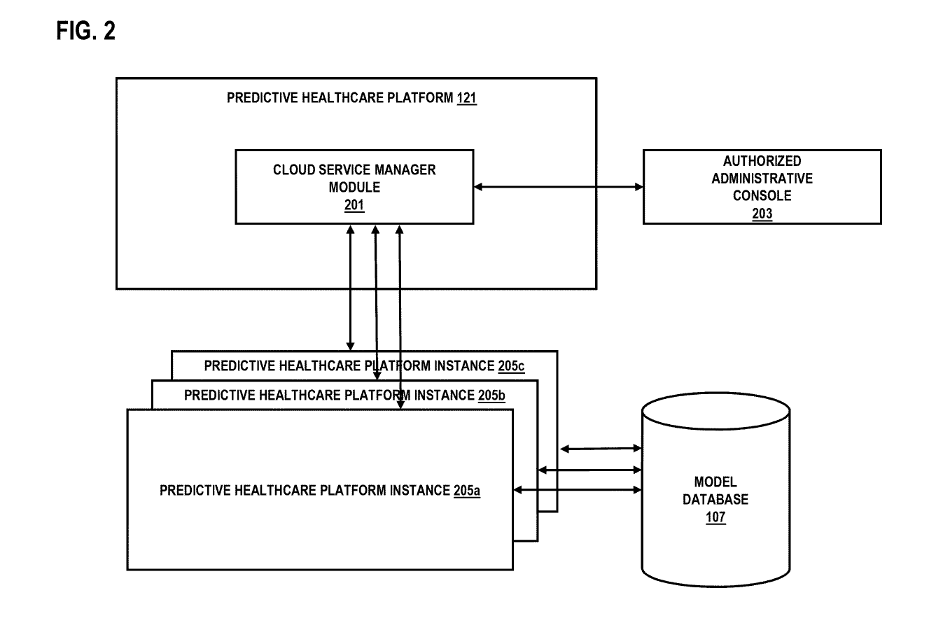

FIG. 2 is a diagram of a system utilizing a predictive healthcare platform over a cloud network, according to one embodiment. In one embodiment, the predictive healthcare platform 103 is controlled by a cloud service manager module 201. The authorized administrative console 203 is used to access the cloud service manager module 201 to use the cloud service manager module 201 to create instances 205a-205c (also collectively referred to as instances 205) of the predictive healthcare platform 103 for a channel partner.

The cloud service manager module 201 generates an instance 205 of the predictive healthcare platform 103 on demand associated with a channel partner. Each instance 205 of the predictive healthcare platform 103 gives the channel partner requesting access through the cloud network (e.g., cloud service 103) the ability to manage the services provided. These services include management of clinical data collection, data exploration, disease model generation, model tuning, health classification and scoring, etc.

For example, the channel partner may use collected clinical data to generate ensemble models for predicting health classifications based on patient variables (e.g., age, sex, resting blood pressure, pain, etc.). This creates an ability to provide predictive health and/or disease classifications that multiple predictive models through the ensemble models.

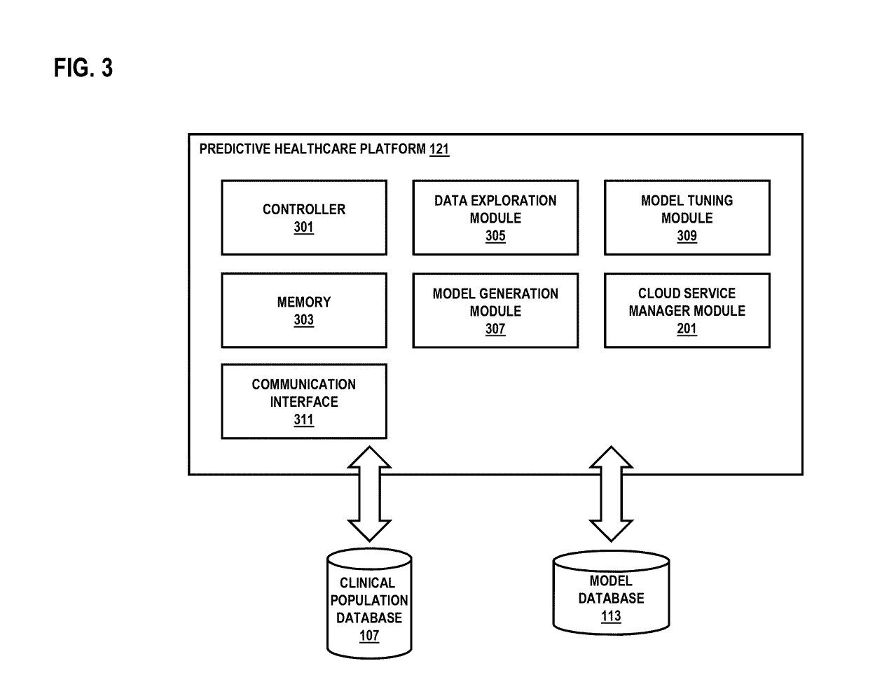

FIG. 3 is a diagram of a predictive healthcare platform 121, according to one embodiment. By way of example, the predictive healthcare platform 121 includes one or more components for providing secured anonymized payments. It is contemplated that the functions of these components may be combined in one or more components or performed by other components of equivalent functionality. In this embodiment, the anonymous settlement services platform 103 includes a controller 301, a memory 303, a data exploration module 305, a model generation module 307, a model tuning module 309, a communication interface 311, and cloud service manager module 201.

The controller 301 may execute at least one algorithm (e.g., stored at the memory 303) for executing functions of the predictive healthcare platform 103. For example, the controller 301 may interact with the data exploration module 305 to explore the clinical population database 107 prior to generating predictive models. In one embodiment, the clinical population database 107 contains information collected from a test or control group individuals including individuals that are healthy and individuals that have particular diseases or health conditions of interest. By way of example, a health variable includes any health related clinical measurement or observation about a patient. In some cases, the clinical population data are unstructured data that can be substantial in size (e.g., depending on the number variables, diseases, health conditions, etc.). For example, some clinical population data may track dozens (e.g., 6 or 7 dozen) of health variables for each individual record. In one embodiment, because of the size and unstructured nature of the data, the system 100 can ingest and domain validate (e.g., via the data transformation server 105) the data via an extract, transform, and load (ETL) process. In one embodiment, the exploration includes determining distribution bias of a disease or health condition of interest with respect to one or more health variables.

In one embodiment, the data exploration module 305 then interacts with the model generation module 307 to generate the model for a disease or health condition of interest and then upload the model to, for instance, the scoring engine server 115 for executing. In one embodiment, the creation of a model involves the generation of a special type of Extensible Markup Language (XML) file that follows the rules of the PMML standard. In one embodiment, the model can incorporate a number of different statistical classification approaches or models including decision trees, linear and Gaussian regression, neural networks, support vector machines, and the like. By way of example, as with most big data transformations, the models generally work well in interpolative mode and extrapolation nearer to the edges. However, there can be rapid deterioration outside of the distribution context of the input variables. The model generation module 307 then stores the models in the model database 113.

Once the models have been created, the model tuning module 309 can use, for instance, scripts to “tune” the models explicitly. In one embodiment, the model tuning module 309 uses a confusion matrix to measure the degree of tuning to perform on the models. Table 1 below provides an example of a confusion matrix.

TABLE 1

| | |
|---|---|
| True Negative | 101 |
| True Positive | 78 |
| False Negative | 12 |
| False Positive | 8 |
| Total | 199 |
| CONFUSION MEASURES | |
| Accuracy | 0.90 |
| Sensitivity | 0.87 |
| Specificity | 0.93 |
| Positive Predictive Value | 0.91 |
| Negative Predictive Value | 0.89 |

As shown in Table 1, in one embodiment, the confusion matrix is a matrix representation of the classification results produced by a model. The matrix contains information about actual and predicted classifications done by a classification system (e.g., the model). For example, the matrix includes a cell which denotes the number of samples classified as true while they are actually true (e.g., a true positive (TP)); and a cell which denotes the number of samples classified as false while they are actually false (e.g., a true negative (TN)). The matrix also includes cells representing misclassifications by the model. For example, there is a cell denoting the number samples classified as false while they actually were true (e.g., a false negative (FN)), and another cell denoting the number of samples classified as true while they actually were false (e.g., false positive (FP)). As shown, classification accuracy, sensitivity, specificity, positive predictive value, and negative predictive value can also be computed by using the elements of the confusion matrix. In one embodiment, the tuning module 309 can apply different scripts to either minimize or maximize any of the elements (e.g., TP, TN, FN, and/or FP) of the confusion matrix. In one embodiment, the degree and types of minimization or maximization can be dependent on the specific disease or health condition that is modeled, and/or determined by a subject matter expert.

In one embodiment, the tuning module 309 uses a 10-fold cross validation to compute a confusion matrix for each model. For example, once the linear regression, neural network, and/or other model type have been separated tuned for an ensemble model, the predictive healthcare platform 121 can use a clustering method (e.g., a meta-learning method). Specifically, meta-learning algorithms take classifiers and turn them into more powerful learners with a higher generalization degree. Meta-learning algorithms can carry out the classifications either by averaging probability estimation and/or by voting to combine the advantages of each classification model that makes up an ensemble model.

In certain embodiments, the cloud service manager module 201 of the predictive healthcare platform 121 can be used to manage make a predictive healthcare service available over the cloud service 103. For example, as previously described, the cloud service manager module 201 generates an instance on demand associated with a channel partner through communication interface 311 managing the services provided. This creates the ability for remote management of the predictive healthcare platform 121 by further limiting exposure of information exposed to the public by unsecured communications.

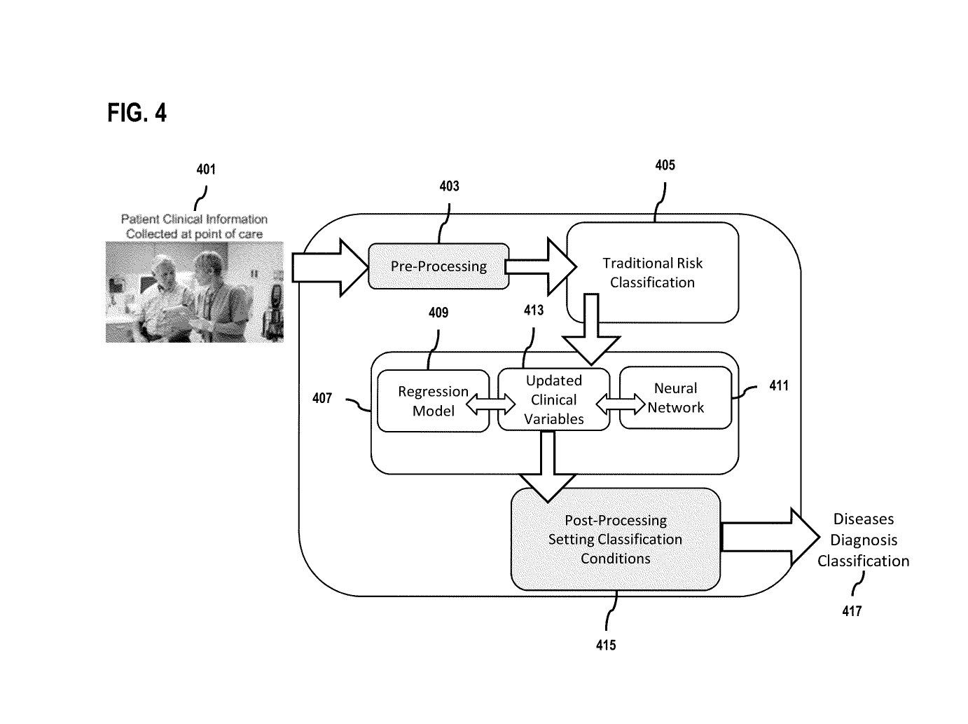

FIG. 4 is a diagram illustrating use of a diagnosis model for determining a diagnosis classification, according to one embodiment. In the example of FIG. 4, a care-giver interacts with a patient to collect patient clinical information at a point of care (e.g., a doctor's office, a hospital, etc.) (at 401). As previously discussed, the care-giver may use a device 109 (e.g., a rugged tablet) to collect health observations or health measurements from the patient. In some embodiments, the care-giver may also use clinical devices with connectivity to the device 109 to collect current patient clinical information. In some embodiments, where permitted or approved by regulatory authorities, the patient may self-collect the patient clinical devices via his own device 109 and/or associated health sensors (e.g., blood pressure monitoring sensors, cardiac sensors, etc.) without interaction with the care-giver. In these embodiments, the system 100 can be used for self-diagnostic purposes and can then be directed to healthcare professionals as warranted.

At 403, the predictive healthcare platform 121 receives the data collected at 401 for pre-processing. By way of example, pre-processing may include converting the data to proper formats, determining outlier information, unit conversion, normalization, etc. The pre-processed data can then be optionally processed using traditional risk-calculation means at 405 prior to processing via the predictive healthcare scoring engine 407. In one embodiment, the scoring engine 407 is loaded with an ensemble model for the disease or health condition of interest. This ensemble model is generated via the processes previously described and can include multiple predictive models (e.g., regression model 409 and neural network model 411) that have been tuned specifically for the classifying the disease or health condition of interest.

In one embodiment, the scoring engine 407 obtains the updated clinical variables 413 that are relevant to the ensemble model, and processes the updated clinical variables 413 using the ensemble model to predict disease or health condition classifications. For example, the regression model 409 and the neural network model 411 that comprise the ensemble model enables near real time risk scoring based on the updated clinical variables 413. More specifically, the scoring of the models 409 and 411 are combined into a predictive scorecard leveraging, for instance, the PMML cloud-based engine 407. In one embodiment, the neural network 411 represents a model trained by the use of a back propagation algorithm and is composed of an input layer containing 22 input nodes, then hidden layers, and an output layer with a single output neuron. All input nodes are connected to all neurons in the hidden layers via, for instance, connection weights. By the same extent, all neurons in the hidden layer are connected to the output neuron of the output layer. In one embodiment, each neuron receives one or more input values (e.g., the updated clinical variables 413), each coming via a network connection, and sends only one output value. An example of PMML mode for PD diagnosis is provided in Table 2 below.

TABLE 2
Summary of the Neural Net model (built using nnet):
A 22-10-1 network with 263 weights.

Inputs: MDVP_Fo, MDVP_Fhi, MDVP_Flo, MDVP_Jitter,
MDVP_Jitter_Abs, MDVP_RAP, MDVP_PPQ, Jitter_DDP,
MDVP_Shimmer, MDVP_Shimmer_dB, Shimmer_APQ3,
Shimmer_APQ5, MDVP_APQ, Shimmer_DDA, NHR, HNR,
RPDE, DFA, spread1, spread2, D2, PPE.
Neural Network build options: skip-layer connections; entropy fitting.
In the following table:
b represents the bias associated with a node
hn represents hidden layer node n
in represents input node n (i.e., input variable 1)
o represents the output node
Weights for node h1:
b->h1 i1->h1 i2->h1 i3->h1 i4->h1 i5->h1 i6->h1 i7->h1 i8->h1 i9->h1
−0.66 0.23 0.29 −0.31 −0.68 −0.36 0.27 0.23 −0.31 −0.18
i10->h1 i11->h1 i12->h1 i13->h1 i14->h1 i15->h1 i16->h1 i17->h1
i18->h1 i19->h1
0.31 −0.02 0.29 −0.50 0.39 0.25 −0.16 −0.55 −0.52 0.25
i20->h1 i21->h1 i22->h1
−0.65 −0.15 −0.03
Weights for node h2:
b->h2 i1->h2 i2->h2 i3->h2 i4->h2 i5->h2 i6->h2 i7->h2 i8->h2 i9->h2
−2.77 3.73 −0.27 −1.14 0.47 0.56 0.44 0.40 0.51 0.32
i10->h2 i11->h2 i12->h2 i13->h2 i14->h2 i15->h2 i16->h2 i17->h2
i18->h2 i19->h2
−0.25 0.46 −0.44 0.04 −0.24 0.42 −9.39 −5.20 −0.75 10.24
i20->h2 i21->h2 i22->h2
−0.29 −3.16 0.04
. . .
Weights for node h10:
b->h10 i1->h10 i2->h10 i3->h10 i4->h10 i5->h10 i6->h10 i7->h10
−1.48 0.10 0.57 2.67 −0.47 0.61 −0.19 −0.09
i8->h10 i9->h10 i10->h10 i11->h10 i12->h10 i13->h10 i14->h10 i15->h10
−0.49 −0.32 −1.56 −0.13 0.51 −0.70 0.13 −0.08
i16->h10 i17->h10 i18->h10 i19->h10 i20->h10 i21->h10 i22->h10
−14.87 −0.60 −2.00 −0.42 −0.89 −2.95 −1.15
Weights for node o:
b->o h1->o h2->o h3->o h4->o h5->o h6->o h7->o h8->o h9->o h10->o
1.66 1.66 21.22 0.68 −0.26 0.48 1.32 −6.32 1.25 1.25 −5.72
i1->o i2->o i3->o i4->o i5->o i6->o i7->o i8->o i9->o i10->o i11->o
−0.21 −0.01 0.08 0.05 0.36 −0.79 −0.46 −0.08 −0.31 −5.44 −0.34
i12->o i13->o i14->o i15->o i16->o i17->o i18->o i19->o i20->o i21->o
i22->o
−0.99 −1.12 0.69 2.29 −0.14 18.40 11.10 2.26 28.64 5.46 6.97

The scoring engine 407 determines a consensus or ensemble output for the ensemble model and preforms post-processing for setting classification conditions (at 415). For example, the classification conditions may specify criteria or rules for determining the consensus or ensemble output. In one embodiment, the criteria or rules may specify that the traditional risk classifications are to be taken into account to determine the predicted diseases diagnosis classification presented at 417.

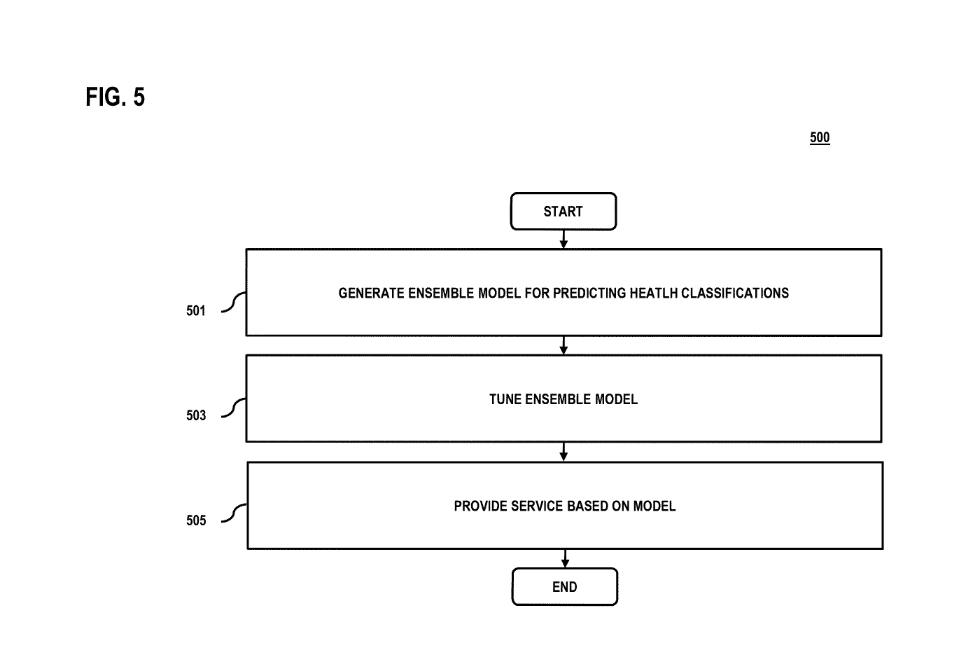

FIG. 5 is a flowchart of a process for providing a predictive healthcare service, according to one embodiment. For the purpose of illustration, process 500 is described with respect to FIG. 1. It is noted that the steps of the process 500 may be performed in any suitable order, as well as combined or separated in any suitable manner. In one embodiment, the predictive healthcare platform 121 performs the process 500. In addition or alternatively, any other component of the system 100 may perform all or a portion of the process 500.

At 501, the predictive healthcare platform 121 generates an ensemble model for predicting one or more health classifications based on one or more health variables. In one embodiment, the ensemble model consists of a plurality of predictive models. In one embodiment, the predictive healthcare platform 121 determines distribution bias information of the one or more health classifications with respect to the one or more health variables. The generating of the ensemble model is then further based on the distribution bias information.

In one embodiment, the plurality of predictive models includes a neural network model, a regression model, a decision tree model, a random forest model, an adaptive boosting model, a support vector machine model, a survival regression model, or a combination thereof. The neural network model and the regression model are described previously. By way of example, the other models are described generally as follows: (1) the decision tree model uses a recursive partitioning approach; (2) the random forest model is a collection of un-pruned decision trees; (3) the adaptive boosting model associates a weight with each observation and the weights are boosted (increased); (4) the support vector machine model uses support vectors to identify a hyper-plane or a line that separates the output classification; and (5) the survival regression model employs censoring (i.e., the phenomenon of having data, like death, relating to some event occurring, but at the point of time the data set was collected, it is not known whether the event might occur to others in the set). The examples of possible predictive models discussed above are by way of illustration and not intended to be limiting. It is contemplated that any predictive model can be incorporated in the embodiments of the ensemble model approach described herein.

At 503, the predictive healthcare platform 121 tunes the ensemble model based on a test data set. As previously described, in one embodiment, the tuning process involves use of a confusion matrix represents a categorization of predicted versus true values (e.g., TP, TN, FP, and FN) that describe correct predictions version miscalculated predictions. Specifically, the predictive healthcare platform 121 constructs a confusion matrix based on a number of false positives, a number of false negatives, a number of true positives, a number of true negatives, or a combination thereof detected in the test set (e.g., the clinical population database 107). By way of example, the test data set includes anonymized health data collected from one or more healthy individuals, one or more individuals with at least one of the one or more health classifications, or combination thereof. In one embodiment, the individual predictive models within an ensemble model can be tuned independently using model-specific confusion matrices. In addition or alternatively, the predictive healthcare platform 121 can generate a confusion matrix for the consensus or ensemble output of the ensemble model and tune the ensemble model in the aggregate.

At 504, the predictive healthcare platform 121 provides a predictive healthcare service based on the ensemble model. In one embodiment, the predictive healthcare service is provided as a cloud-based service whereby predictive healthcare models and associated data are provided via backend servers and components of the cloud service 103. In one embodiment, the cloud service 103 is cloud-centric infrastructure applicable to various disease models as well as other horizontal applications outside of healthcare. In addition or alternatively, the predictive healthcare service can be provided as a local service is that is wholly or partially contained at the device 109 and/or the application 111.

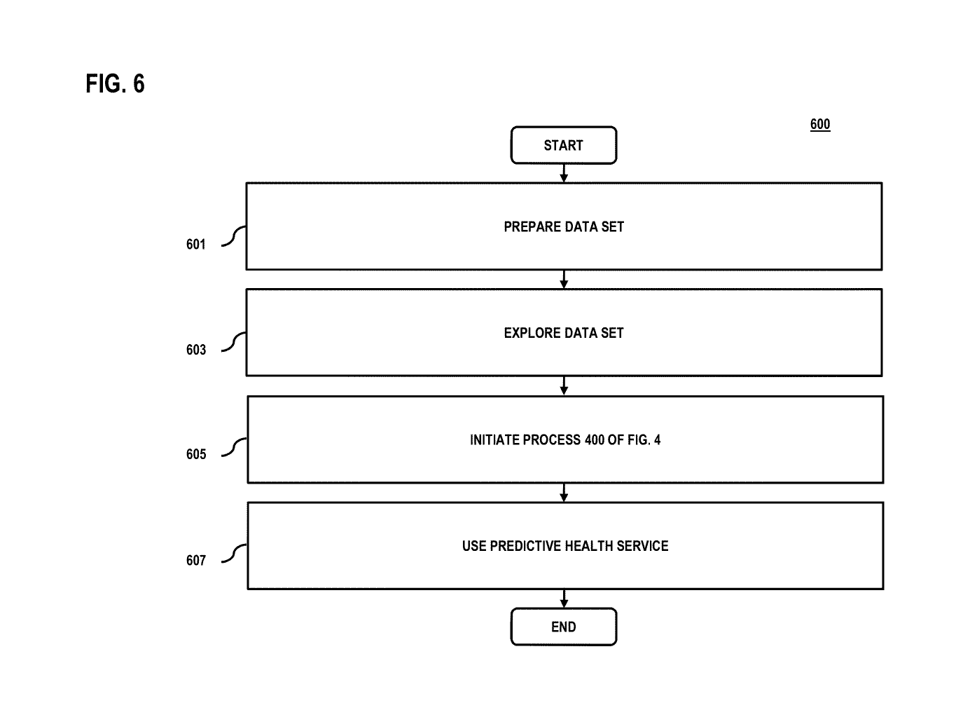

FIG. 6 is a flowchart of a process for preparing and exploring data sets for use in a predictive healthcare service, according to one embodiment. For the purpose of illustration, process 600 is described with respect to FIG. 1. It is noted that the steps of the process 600 may be performed in any suitable order, as well as combined or separated in any suitable manner. In one embodiment, the predictive healthcare platform 121 performs the process 600. In addition or alternatively, any other component of the system 100 may perform all or a portion of the process 600.

At 601, the predictive healthcare platform 121 locates and prepares a data set for model generation. In one embodiment, preparation of the data set may include an ETL process ingests unstructured clinical population data for analysis. In some embodiments, the preparation process may also include anonymizing the clinical population data so that the data cannot be identified or attributed to a specific individual.

At 603, the predictive healthcare platform 121 explores the data set, for instance, to understand underlying distribution biases and correlations. As part of the exploration processes, variable optimization scripts can be executed to reduce the number of health variables that are to be processed in the data set to generate the predictive models. In one embodiment, the role of the variable optimization script is to minimize over-fitting (e.g., a problem when there are extra terms in a model creating a fit for random variations in data as if they were deterministic) and eliminate variables that do not contribute “significantly” to the outcome determination.

By way of example, the predictive healthcare platform 121 can support a variety of variable reduction techniques including: (1) principal component analysis, (2) hierarchical correlation dendrogram, and/or (3) association rule analysis. These techniques are provided as illustration and are not intended to be limiting. Specifically, principal component analysis identifies the relative importance of variables in explaining the variation found within the test data set (e.g., the clinical population database 107). For example, the Eigen Values of the Covariance matrix (EVCM) and the Scaled Singular Value decomposition (SSVD) approaches to deriving principal components are both supported by the predictive healthcare platform 121.

In one embodiment, the hierarchical correlation dendrogram approach presents the correlated view (e.g., relationship) of the variables of the data set showing potential groupings of variables that are highly correlated. This provides an immediate view on the reduction of the number of variables that are to be included in the modeling. In one embodiment, the association rule analysis approach (also called basket analysis) identifies relationships or affinities between observations and/or between variables to identify variables for reduction.

For example, with respect to CAD, anonymized data sets can be collated from contributions from participating cardiology centers. This collated data set may include, for instance, more than six dozen variables which can be reduced to approximately one dozen that are linear valued and distributed continuously across the range of patients using the preparation and exploration approaches described above. Similarly, a PD data set (e.g., containing thousands of voice recordings from PD patients) can be abstracted and anonymized for processing and exploration. In this example, characteristics or variables associated with the voice recordings can be explored for correlation to PD and modeling.

After preparation and exploration of the data, the predictive healthcare platform 121 can initiate the process 400 of FIG. 4 to generate predictive models, tune the models, and provide a cloud-based predictive healthcare service (at 607). On creation of the service, the predictive healthcare platform 121 enables care-givers and patients (e.g., if permitted or approved by regulatory authorities) use the predictive healthcare service for predicting health classifications based patient clinical data.

In one embodiment, the predictive healthcare platform 121 enables use of the service by generating an ensemble output for the ensemble model based at least in part on a clustering of one or more respective outputs of the plurality of predictive models for a user data set (e.g., a patient's clinical data). By way of example, the user data set consists of the one or more health variables determined for a user or patient, and the ensemble output includes one or more predicted health classifications for the user data set. In one embodiment, the predictive healthcare platform 121 determines the user data set from one or more clinical devices, one or more user devices, or a combination thereof. For example, the platform 121 may have connectivity with the clinical devices, the user devices, etc. to capture health measurements and/or observations made by the user and/or care-giver.

In one use case wherein the one or more health classifications include a Parkinson's disease diagnosis, the predictive healthcare platform 121 can collect a voice measurement for the user or patient to represent, at least in part, the user's clinical data, and submits the voice measurement for scoring and classification. In some cases, the collected clinical data may be automatically stored in the user's patient records. In another use case wherein the one or more health classification include a coronary artery disease diagnosis, the predictive healthcare platform 121 can collect clinical measurements related to CAD for the user and submits the collected clinical measurements as the user data set or clinical data for scoring/classification.

The processes described herein for providing a predictive healthcare service can be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

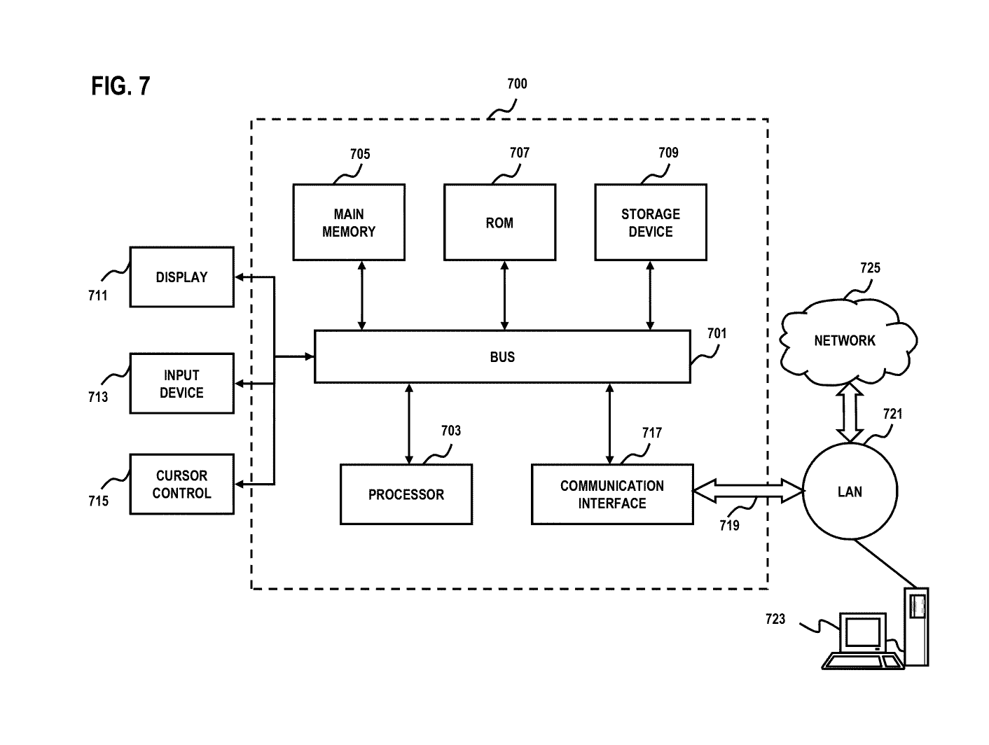

FIG. 7 illustrates computing hardware (e.g., computer system) upon which an embodiment according to the invention can be implemented. The computer system 700 includes a bus 701 or other communication mechanism for communicating information and a processor 703 coupled to the bus 701 for processing information. The computer system 700 also includes main memory 705, such as random access memory (RAM) or other dynamic storage device, coupled to the bus 701 for storing information and instructions to be executed by the processor 703. Main memory 705 also can be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711.

According to an embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. Thus, embodiments of the invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for EthernetTM or an Asynchronous Transfer Mode (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

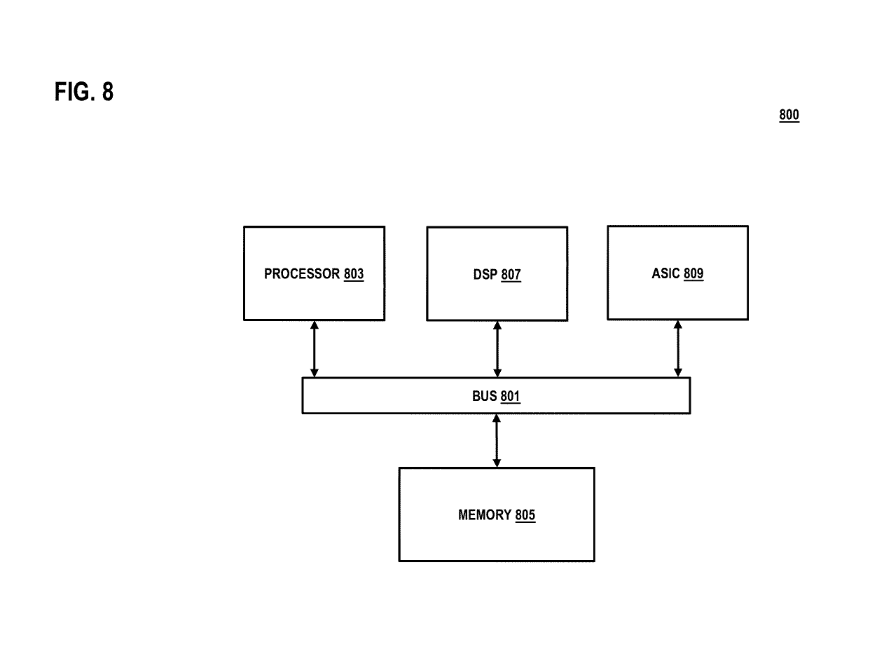

FIG. 8 illustrates a chip set 800 upon which an embodiment of the invention may be implemented. Chip set 800 is programmed to securely transmit payments and healthcare industry compliant data from mobile devices lacking a physical TSM and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of FIGS. 4-6.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 805 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
generating an ensemble model for predicting one or more health classifications based on one or more health variables, the ensemble model consisting of a plurality of predictive models;
tuning the ensemble model based on a test data set; and
providing a predictive healthcare service based on the ensemble model.

2. A method of claim 1, further comprising:
generating an ensemble output for the ensemble model based at least in part on a clustering of one or more respective outputs of the plurality of predictive models for a user data set,
wherein the user data set consists of the one or more health variables determined for a user; and
wherein the ensemble output includes one or more predicted health classifications for the user data set.

3. A method of claim 2, further comprising:
determining the user data set from one or more clinical devices, one or more user devices, or a combination thereof.

4. A method of claim 2, wherein the one or more health classifications include a Parkinson's disease diagnosis, the method further comprising:
collecting a voice measurement for the user; and
submitting the voice measurement as the user data set.

5. A method of claim 2, wherein the one or more health classification include a coronary artery disease diagnosis, the method further comprising:
collecting one or more clinical measurements for the user; and
submitting the one or more clinical measurements as the user data set.

6. A method of claim 1, further comprising:
determining distribution bias information of the one or more health classifications with respect to the one or more health variables,
wherein the generating of the ensemble model is further based on the distribution bias information.

7. A method of claim 1, wherein the plurality of predictive models includes a neural network model, a regression model, a decision tree model, a random forest model, an adaptive boosting model, a support vector machine model, a survival regression model, or a combination thereof.

8. A method of claim 1, further comprising:
constructing a confusion matrix based on a number of false positives, a number of false negatives, a number of true positives, a number of true negatives, or a combination thereof detected in the test data set,
wherein the tuning of the ensemble model is based on the confusion matrix.

9. A method of claim 1, wherein the test data set includes anonymized health data collected from one or more healthy individuals, one or more individuals with at least one of the one or more health classifications, or combination thereof.

10. An apparatus comprising:
a processor configured to:
generate an ensemble model for predicting one or more health classifications based on one or more health variables, the ensemble model consisting of a plurality of predictive models;
tune the ensemble model based on a test data set; and
provide a predictive healthcare service based on the ensemble model.

11. An apparatus of claim 10, wherein the processor is further configured to:
generate an ensemble output for the ensemble model based at least in part on a clustering of one or more respective outputs of the plurality of predictive models for a user data set,
wherein the user data set consists of the one or more health variables determined for a user; and
wherein the ensemble output includes one or more predicted health classifications for the user data set.

12. An apparatus of claim 11, wherein the processor is further configured to:
determine the user data set from one or more clinical devices, one or more user devices, or a combination thereof.

13. An apparatus of claim 11, wherein the one or more health classifications include a Parkinson's disease diagnosis, and wherein the processor is further configured to:
collect a voice measurement for the user; and
submit the voice measurement as the user data set.

14. An apparatus of claim 11, wherein the one or more health classification include a coronary artery disease diagnosis, and wherein the processor is further configured to:
collect one or more clinical measurements for the user; and
submit the one or more clinical measurements as the user data set.

15. An apparatus of claim 10, wherein the processor is further configured to:
determine distribution bias information of the one or more health classifications with respect to the one or more health variables,
wherein the generating of the ensemble model is further based on the distribution bias information.

16. An apparatus of claim 10, wherein the plurality of predictive models includes a neural network model, a regression model, a decision tree model, a random forest model, an adaptive boosting model, a support vector machine model, a survival regression model, or a combination thereof.

17. An apparatus of claim 10, wherein the processor is further configured to:
constructing a confusion matrix based on a number of false positives, a number of false negatives, a number of true positives, a number of true negatives, or a combination thereof detected in the test data set,
wherein the tuning of the ensemble model is based on the confusion matrix.

18. An apparatus of claim 10, wherein the test data set includes anonymized health data collected from one or more healthy individuals, one or more individuals with at least one of the one or more health classifications, or combination thereof.

19. A system comprising:
a predictive healthcare platform configured to generate an ensemble model for predicting one or more health classifications based on one or more health variables, the ensemble model consisting of a plurality of predictive models; and to tune the ensemble model based on a test data set; and
a scoring engine server configured to provide a predictive healthcare service based on the ensemble model.

20. A system of claim 19, wherein the predictive healthcare platform is further configured to:
generate an ensemble output for the ensemble model based at least in part on a clustering of one or more respective outputs of the plurality of predictive models for a user data set,
wherein the user data set consists of the one or more health variables determined for a user; and
wherein the ensemble output includes one or more predicted health classifications for the user data set.
